(19) United States
(12) Patent Application Publication
(10) Pub. No.: US 2017/0195640 A1
(43) Pub. Date: Jul. 6, 2017

(54) WIRELESS SECURITY SYSTEM

(71) Applicant: ADVANCED WIRELESS INNOVATIONS LLC, Santa Monica, CA (US)

(72) Inventor: Shawn Pasternak, Simi Valley, CA (US)

(21) Appl. No.: 15/400,928

(22) Filed: Jan. 6, 2017

Related U.S. Application Data
(60) Provisional application No. 62/290,901, filed on Feb. 3, 2016.
(60) Provisional application No. 62/275,771, filed on Jan. 6, 2016.

(51) Int. Cl. H04N 7/18; G08B 3/10; H04N 5/33; H04R 29/00; G06K 9/00; G10L 13/04; H04N 5/232; H04W 4/12; G10L 15/26

(52) U.S. Cl. CPC H04N 7/186; H04W 4/12; G08B 3/10; H04N 5/332; G10L 15/265; G06K 9/00771; G10L 13/043; H04N 5/232; H04R 29/00; H04W 4/008

(57) ABSTRACT

A wireless doorbell having a housing, the housing having a rear portion and a front portion, the rear portion configured to be secured to a support and the front portion configured to be secured to the rear portion. The wireless doorbell having a sensor configured to detect an object in a vicinity of the wireless doorbell, a camera configured to be activated and obtain at least one image, and a microphone configured to obtain audio signals. A wireless transmitter can be configured to transmit, to the server from the wireless doorbell, a signal indicative of the object being detected, the at least one image and the audio signals. The server can be configured to perform image recognition on the at least one image and speech recognition analysis on the audio signals to determine a context of the object being detected in the vicinity of the wireless doorbell.

### CROSS-REFERENCE TO RELATED APPLICATIONS

The present application claims priority to Application Ser. No. 62/275,771, titled “WIRELESS SECURITY SYSTEM,” filed on Jan. 6, 2016, and to Application Ser. No. 62/290,901, titled “WIRELESS SECURITY SYSTEM,” filed on Feb. 3, 2016, the disclosures of which are incorporated herein by reference in their entireties for all purposes.

### TECHNICAL FIELD

The subject matter described herein relates to a wireless security system.

### BACKGROUND

When visitors come to a house or building and knock on the door or ring a doorbell, the occupants have to go to the door in order to ascertain who is visiting. This invariably reveals the presence of occupants in the house to the visitors. Alternatively, when the occupants of the building are not in the building the visitor must leave without providing an indication that they are there.

### SUMMARY

In one aspect a wireless security system is described. The wireless security system can include one or more features consistent with the present description. The wireless security system can include a server and a wireless doorbell. The wireless doorbell can include a housing. The housing can have a rear portion and a front portion. The rear portion can be configured to be secured to a support and the front portion configured to be secured to the rear portion. The wireless doorbell can include a sensor configured to detect an object in a vicinity of the wireless doorbell. The wireless doorbell can include a camera configured to be activated and obtain at least one image in response to the sensor detecting the object. The wireless doorbell can include a wireless transmitter configured to transmit, to the server, a signal indicative of the object being detected and the at least one image.

The server can be configured to perform image recognition on the at least one image received from the wireless doorbell to determine an identity of the object. The server can be configured to transmit, to a mobile device of a user associated with the wireless doorbell, a notification of the detection of the object, the notification including the identity of the object.

The detected object can be a visitor and the wireless doorbell can further comprise a microphone for detecting audio signals from the visitor and wherein the signal includes an indication of the audio signals.

The server can be configured to perform speech recognition analysis on the audio signals to detect one or more words spoken by the visitor. The server can be configured to translate the one or more words into text. The server can be configured to transmit the text to a mobile device associated with a user of the wireless doorbell.

The server can be configured to determine a context of the text including an intended recipient of the audio signals and to transmit the text to the mobile device associated with the intended recipient.

The server can be configured to receive a textual message from a mobile device associated with a user of the wireless doorbell. The server can be configured to convert the textual message to an audible message. The server can be configured to transmit the audible message to the wireless doorbell for playing through a speaker of the wireless doorbell.

The wireless doorbell can comprise a microphone. The wireless doorbell can be configured to monitor sounds in the vicinity of the wireless doorbell over a period of time and to generate a background noise profile based on the monitored sounds. The wireless doorbell can be configured to activate the camera in response to a detected sound exceeding one or more bounds of the background noise profile.

The wireless doorbell can have a low power mode. The low power mode can cause the camera to be inactive.

The server can be configured to store the at least one image in electronic data storage.

The wireless doorbell can be configured to enter an active mode in response to a signal received from a mobile device associated with a user of the wireless doorbell, the wireless doorbell being in an active mode causing the camera to obtain at least one image.

Implementations of the current subject matter can include, but are not limited to, methods consistent with the descriptions provided herein as well as articles that comprise a tangibly embodied machine-readable medium operable to cause one or more machines (e.g., computer processors, etc.) to result in operations implementing one or more of the described features. Similarly, systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is an illustration of a system having one or more features consistent with the current subject matter;

FIG. 2 is an illustration of a system having one or more features consistent with the current subject matter; and

FIG. 3 is an illustration of a process having one or more features consistent with the present description.

### DETAILED DESCRIPTION

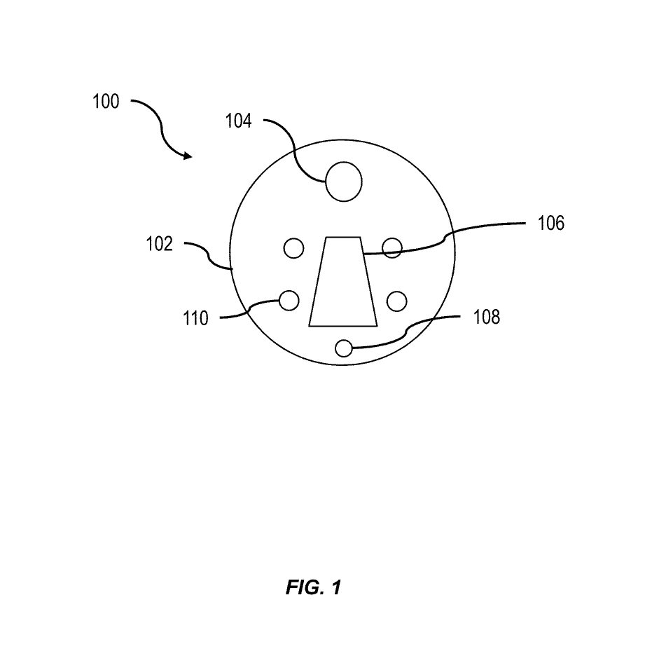

FIG. 1 is an illustration of an security system 100 having one or more components consistent with the present description. The security system 100 can include a housing 102. The housing can include a front portion and a rear portion. The rear portion can be configured to be attached to a support structure. The support structure can include a wall, fence post, door, or the like. The rear portion can be attached to the support structure with fasteners, such as screws, adhesive tape, adhesive, Velcro®, mechanical attachment systems, or the like. The front portion can be configured to be attached to the rear portion using one or more connectors. The connector(s) can include a fastener. The fastener can include a tamper-resistant screw, for example, a Security Torx® screw, Security Hex® screw, Spanner Head® screw, Clutch® screw, or the like. In some variations, the housing 102 can include a rear portion and no front portion. The component(s) of the security system 100 can attach to the rear portion of the security system 100.

The components of the security system 100 can include a camera 104, a sensor 106, a microphone 108, a speaker or the like.

The camera 104 can be configured to provide still and/or video images having a predetermined resolution. The predetermined resolution can be set at a level to convey sufficient information about the area in the field of view of the camera 104 to a user of the security system 100. The camera 104 can be mounted via a secured mounting bracket. The camera 104 can be secured with double stick tape or screws. Screws can include security screws as described above.

The sensor 106 can include a button, a motion sensor, an infra-red detector, a proximity sensor, camera, or the like. The button can include a push-button, touch-sensitive button, or the like.

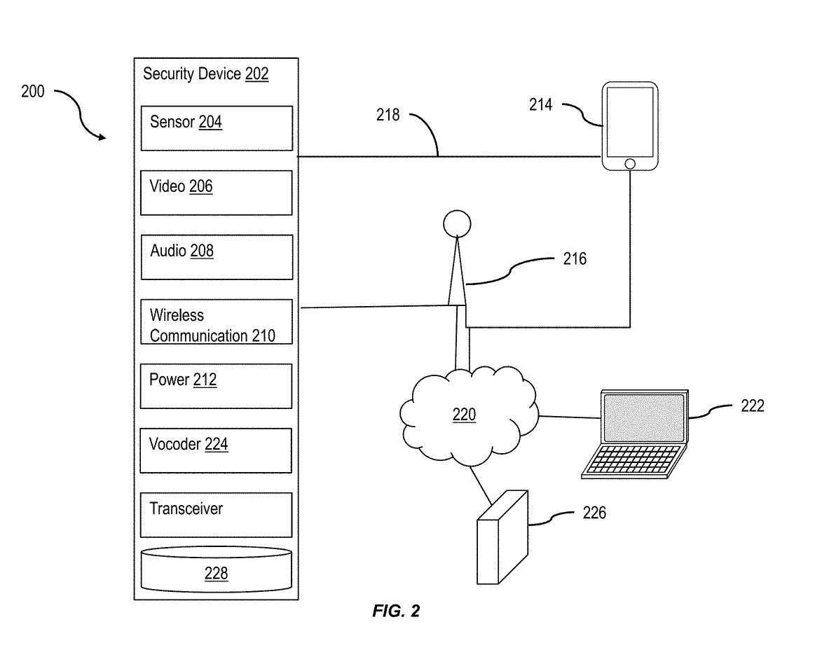

FIG. 2 is a schematic diagram of a security communication system 200 having one or more features consistent with the present disclosure. The security communication system 200 can include a security device 202. Security device 202 can have one or more features consistent with security system 100 illustrated in FIG. 1. Security device 202 can include a sensor component(s) 204. Sensor component(s) 204 can include a sensor, such as sensor 106 illustrated in FIG. 1. Sensor component(s) 204 can include software and/or hardware configured to determine when the sensor has been triggered. Triggering of the sensor can include depressing of a button, detection of motion by a motion detector, detection of something within the proximity of a proximity sensor, detection of something within the field of view of an IR sensor, detection of something within the field of view of a camera, or the like. The sensor components 204 can be configured to limit triggering based on one or more triggering parameters. For example, the motion detector can be configured to be triggered in response to an indication that an object above a certain size is within the field of view of the motion detector. The proximity sensor can be similarly limited. The sensor(s) 204 can be configured to not activate in response to a relatively small object entering the field of detection of the sensor(s). For example, if a bird, cat, dog, or the like, entered a sensor(s) 204 field of detection, the sensor(s) may be configured to not be triggered by the bird, cat, dog, or the like.

The sensor component(s) 204 can be configured to facilitate determination of a number of objects in the field of detection of the sensor(s). In some variations, the sensor component(s) can be configured to identify a type of object in the field of detection. For example, the sensor(s) can be configured to determine whether an object in the field of detection of the sensor(s) is a human, an animal, a package, a vehicle, or the like.

The security device 202 can comprise video components 206. The video components 206 can include hardware and/or software to support a camera, such as camera 104. The video components 206 can be configured to activate the camera in response to a triggering of one or more of the sensor components 204. The video components 206 can be configured to obtain still or video images from the camera and transmit the image information to one or more other components of the security device 202, or other components of the surveillance system 200. The video components 206 can be configured to capture snapshots taken by the camera. Snapshots can be initiated by a triggering of a sensor component(s) 204, in response to a request from a user, or the like.

The security device 202 can include one or more audio components 208. The audio component(s) 208 can be configured to include software and/or hardware to control a microphone, such as microphone 108 illustrated in FIG. 1, a speaker, or the like. The audio components 208 can be configured to facilitate two-way communication between a microphone and/or speaker at the security device 202, and one or more other components of the surveillance system 200. The audio component(s) 208 can be configured to facilitate echo cancellation, errant noise cancellation, or the like. The audio component(s) 208 can be configured to detect sounds associated with non-background noise. For example, the audio component(s) 208 may be configured to not be triggered in response to a sound being detected that is associated with background noise. Background noise sounds may be stored in a memory or an online database and the security device 202 may be configured to query the background noise sounds to confirm that the detected sounds are background sounds. In some variations, the audio component(s) 208 can be configured to monitor sound types and sound levels over a period of time at a location where the security device 202 is being used. The security device 202 can generate a background noise profile based on the monitoring of the sounds types and sound levels. In response to a deviation of the background sound types and sound levels, as detected by the one or more audio component(s) 208, the security device 202 can be configured to enter into an active mode. When in an active mode, the security device 202 can be configured to store image data obtained by the camera and/or audio data obtained by the microphone.

The security device 202 can include wireless communication components 210. The wireless communication components 210 can include a wireless transceiver. The wireless transceiver can be configured to transmit and/or receive data. The wireless transceiver can be configured to communicate using one or more wireless protocols that include one or more of, for example, WiFI, Bluetooth, Near Field Communication, sub-GHz, or the like. The wireless communication components 210 can be configured to wirelessly communicate in a number of protocols simultaneously, or intermittently.

The wireless communication components 210 can be configured to communicate with one or more of a base station 216, a mobile device 214, or the like. The base station 216 can be a home WiFi router. Communication between the security device 202 and the mobile device 214 can be through the base station 216, or directly 214.

A software application can be provided for installation in a mobile device 214. The softwarwe application can be configured to facilitate communication between the mobile device 214 and the security device 202. The software application can be configured to facilitate user interaction with the security device 202 through the mobile device 214. Interaction with the security device 202, through the mobile device 214, can include activtiing the security device 202, activitating one or more components of the security device 202, deactivating the security device 202, unlocking a door lock associated with the security device 202, changing one or more settings and/or parameters of the security device 202, communicate with a visitor through the security device 202, or the like.

The security device 202 can include power components 212. Power components 212 can include software and/or hardware for managing power delivery to, and consumption by, the security device 202. Power components 212 can include a battery for providing power to the components of the security device 202. The battery can be, for example, an internal Lithium-polymer cell. The battery can be charged through an external port, for example, a micro USB input. The security device 202 can be charged from mains power, a portable battery, a computer, or the like. The power components 212 can include wireless charging components, whereby the security device 202 can be placed on a wireless charging base station, or a wireless charging base station can be placed adjacent the security device 202 for charging. The battery can be configured to provide power to the security device 202 for a time of between 6-9 months on a single charge.

In some variations, the security device 202 can have dimensions of approximately 80 mm by 80 mm by 29 mm, the battery can be an internal battery, and the battery can be configured to power the security device 202 for a period of 6-9 months.

The power components 212 can be configured to cause the security device 202 to enter a low-power mode. When in a low-power mode the components of the security device 202 can be consuming no power or a power level much reduced compared to being in a higher-power mode, such a mode can be referred to as an inactive mode. The power components 212 can be configured to cause one or more of the components of the security device 202 to enter into an active mode. An active mode can be entered into by one or more components of the security device 202 in response to a triggering event. For example, sensor component(s) 204 can be configured to be in an inactive mode where the sensor components 204 are configured to detect above a predetermined level of interaction with the security device 202. The predetermined level of interaction can be any type of movement or presence within the field of detection of a sensor, movement or presence of an object having an amount or size above a certain threshold, a level of movement above a threshold level of movement, or the like. One example, of an interaction can be the pressing of a button by a visitor, or the like.

A triggering event can be an interaction by a user with a mobile device 214 that is configured to communicate with the security device 202. The mobile device 214 can include a software application that allows the user to access one or more features of the security device 202. For example, a user can activate one or more of the video components 206 of the security device 202 using the software application on the mobile device 214. In response to activating the camera of the security device 202, video images, and/or audio data, can be transmitted from the security device 202 to the mobile device 214 and presented on a screen, and/or played through speakers, of the mobile device.

In some variations, the security device 202 can use a peer-to-peer connection 218 to another device, such as a mobile device 214. The peer-to-peer connection 218 can be a WiFi network, Bluetooth network, or the like. The mobile device 214 and/or the security device 202 can be configured to initiate the peer-to-peer connection. The mobile device 214 can have an application installed that is configured to facilitate interaction with the security device 202. Over this connection 218, the mobile device 214 can pass network credentials for a local network, such as the network supported by base station 216. The local network can be a WiFi network, sub-GHz network, or the like. After connecting with a local network, the security device 202 and/or the mobile device 214 can be configured to disconnect from the peer-to-peer connection 218. The security device 202 can connect to the local network and access a wider area network, such as the Internet 220.

When the security device 202 is connected to the local network, the power components 212 can be configured to cause the security device 202 to enter into a low power mode. A low power mode can optimize battery life. The wireless communication component(s) 210 can be configured to periodically awaken the network transceiver and connect to the local network base station 216 and then return to the low power mode. In the case of a WiFi local network, for example, this keeps the WiFi base station, or router, from dropping the connection with the security device 202 and keeps the data connection with Internet 220 active, so that remote commands can be sent from a mobile device 214 to the security device 202.

The mobile device 214 can be configured to communicate with the security device 202 through the Internet 220. With the security device's 202 connection to the Internet 220 maintained, the user can send a request from their mobile device 214 to the security device 202 to wake it up or cause it to enter an active mode. In response to waking up the security device 202, the mobile device 214 can request, and/or the security device 202 can initiate, transmission of video images from the camera of the security device 202 to the mobile device 214 over the Internet. In some variations, audio signals can be sent between the mobile device 214 and the security device 202. In some variations, data from the one or more sensor components 204 can be transmitted from the security device 202. Data can include wireless communication information/status, power state or level, or the like. In some variations, where the mobile device 214 is connected to the local network connection that is supported by the base station 216, the video images and/or audio signals can be transmitted through the local network connection to the mobile device 214. One use case can include, for example, a user initiating this “instant view” feature, in response to a knock at the door, or some sound being detected from outside, even when there is no triggering event detected by the security device 202 causes the security device 202 to enter an active mode.

In another typical use case, when the security device 202 is in an inactive, or low power mode and a visitor approaches the security device 202, the security device 202 can enter an active mode. For example, the visitor can enter the field of detection of a motion detector, proximity sensor, camera, or the like. The visitor can press a button on the security device 202, speak to the security device 202, or the like. The security device 202 can include a chime. The chime can be configured to ring in response to the security device 202 detecting a visitor. In some variations, the security device 202 can be configured to interact with an external chime, causing the external chime to ring in response to the visitor.

The security device 202, such as security system 100, can include one or more indicators that provide an indication to the visitor that someone has been notified of their presence. The one or more indicators 110 can be, for example, LED lights disposed about the housing 102, as illustrated in FIG. 1.

A user of the security device 202 can receive a notification on their mobile device 214. The notification can be facilitated through a software application installed on the mobile device 214. The notification can include a pop-up message along with an optional audible ring. The user can ignore the message or accept it through interactions with the mobile device 214. If accepted, the software application can be configured to initiate an instance of a graphical user interface on the mobile device 214. The graphical user interface can include the video feed from the camera 104, of the security system 100.

Audio, obtained by the microphone 108, can be fed to the mobile device 214 and played to the user through speakers of the mobile device 214. In some variations, the graphical user interface and/or software application can be intiated on the mobile device 214 with the microphone of the mobile device 214 turned off. Similarly, the speakers of the mobile device 214 can be turned off when the graphical user interface is initiated. The user of the mobile device 214 can activate sound on the mobile deice 214. This functionality can be provided so as to not alert the visitor of the user's presence within the property, or that the user actually received the notification that the visitor was present. The user is not exposed, in this way through audible clues.

The graphical user interface can be configured to facilitate the user activating the speakers, microphone, and other components of the mobile device.

The software application can facilitate modification of the settings of the security device 202, the mobile application, the base station, or the like.

If the user does not accept the notification within a predefined period of time, the security device 202 can be configured to enter into a voice message mode allowing visitors to leave a message for the user. A pre-recorded message can be played to the visitor through one or more speakers of the security device 202 to inform them that they are to leave a message.

The security device 202 can have memory storage for storing data obtained by the security device 202. Data can include one or more log files associated with the security device 202 produced by one or more components of the security device 202, images obtained by the camera and/or the audio obtained by the microphone. In some variations, the security device 202 is configured to transmit the data to a remote storage device. The remote storage device can be a memory storage device in communication with the security device 202 over a local network. The memory storage device can be associated with a larger computer system. The remote storage device can be cloud storage accessed through the local network, or through the Internet.

The user, or owner of the property, will receive a message on their mobile device that a call from a visitor was missed. The message left by the visitor can be transmitted to the mobile device 214 for playback by the user.

In response to a call imitated by the interaction of a visitor with the security device 202, whether passively or actively, the user can accept the call and cause the microphone and/or speakers of the mobile device 214 to become activate. The mobile device 214 and the security device 202 can be configured to conduct a two-way communication with each other allowing the visitor and the user to converse. During the conversation images obtained by the camera 104 can be transmitted to the mobile device.

The user can end the call through the graphical user interface presented via the mobile device.

During a call the communication, including video and/or audio, can be routed from security device 202, through the local network, to the Internet, using the Wide-Area-Network IP address of the base station, to an access point closes to the mobile device 214. If the mobile device 214 is also connected to the local network, the communication can be transmitted from the security device 202 to the mobile device 214 through the local network without the communication being transmitted over the Internet.

Direct transmission from the security device 202 to the mobile device 214, without passing through centralized servers, can facilitate reduction in fees associated with cloud storage or cloud processing, for the provider of the security device 202 and associated services.

In some variations, a service can be provided to route communications through a cloud processor or cloud storage server to facilitate cloud storage of communications, facial recognition, speech-to-text services, object recognition, or the like.

Any number of mobile devices can be configured to interact with the security device 202. Software applications can be configured to facilitate granting access to mobile devices to a particular security device 202. For example, an access code can be required to access the security device 202, or a grant of permission by a mobile device operating through a master account can be required to allow another mobile device to access the security device 202.

In some variations, the number of mobile device that can access the security device 202 at any one time can be limited.

In some variations, all mobile devices granted access to a particular security device 202 will be notified in response to a triggering event detected by the security device 202. In response to acceptance of a call by one mobile device, the other mobile devices can be barred from accessing the communication. In some variations, other mobile devices can be invited to the communication by the first mobile device to accept the call. In some variations, one mobile device can be configured to intercept a communication and override a communication between the security device and another mobile device. For example, an adult's mobile device can be configured to allow a user of the adult's mobile device to take over communications between the security device 202 and a child's mobile device.

The security device 202 and/or application stored on the mobile computing device 214 can be configured to be integrated with one or more door locks. The mobile application installed on the mobile device 214 can be configured to cause the one or more door locks to activate such that a door can be unlocked, or locked, through the mobile application, or in response to one or more triggering events detected at the security device 202.

A web application can be provided. The web application can be accessed by a computing device 222. The web application can be configured to facilitate modification of one or more modes of operation of the security device 202. Computing device 222 can be configured to activate the camera of the security device 202 through the web application.

The security device 202 can be configured to facilitate automated attendant functionality. The automated attendant functionality can include providing an automated response to a triggering event. The automated response can include playing a recorded greeting to a visitor in response to the triggering event. For example, the security device 202 can be configured to request, from the visitor, the purpose of their visit. The security device 202 can include a vocoder 224 configured to analyze and/or synthesize human voice signals. When the visitor speaks and provides a reason for their visit, the vocoder can facilitate analysis of the visitor's voice signals that are recorded by the microphone 108 of the security device.

The analysis of the voice signals from the visitor can include measuring how the voice signals' spectral characteristics change over time to reduce the amount of information needed to store speech. In some variations, the vocoder can translate the speech recording into a series of number reducing the amount of data required to store and transmit the speech. Vocoder 224 can include a speech codec. The speech codec can be configured to facilitate the data compression of digital audio signals containing speech.

In some variations, the security device 202 can be configured to analyze some or all of the recorded voice signals. In some variations, the recorded voice signals can be analyzed external to the security device 202. The security device 202 can be configured to transmit the recorded voice signals and/or the compressed voice signals to a voice analysis device. The voice analysis device can be located at a base station, such base station 216. The base station 216 can be located within the building associated with the security device 202. In some variations, the voice analysis device can be located remotely from the building, such as at server 226. Server 226 can be provided by a third-party voice analysis service. The recorded voice signals and/or compressed voice signals can be transmitted from the security device 202 to the server 226 over a WAN, such as the Internet 220.

In some variations, the security device 202 can include a voice analysis system configured to determine or recognize a limited set of content of the speech from a visitor. Any recorded voice signals that cannot be recognized or determined by the security device 202 can be transmitted to the external voice analysis device for further processing.

The security device 202 can be configured to generate a code associated with the results of the analysis on the recorded voice signals. Where the analysis is performed by the external voice analysis device, the external voice analysis device can be configured to transmit the results of the analysis back to the security device 202. In some variations, the results can be a code linked to a look-up table.

The security device 202 can store a look-up table in electronic storage 228. The look-up table can include actions that the security device 202 can take in response to determining that the recorded speech signals relate to a code. The security device 202 can be configured to receive the code, look up the code in the look-up table, and perform the associated action.

For example, the visitor may say a person's name. The name may be associated with someone connected with the building. Where the building is a house, the name may be associated with a resident of the house. When the visitor says the name, the voice signals from the visitor can be recorded and analyzed. The analysis can reveal that the visitor said a name recognized by the system. This name can be associated with a code in a look-up table. The associated action can, for example, transmitting a message to a mobile device associated with the named person. As another example, the visitor may say that they are here to deliver a package. The security device 202 may be configured by the occupants of the building to request that packages are left at the back door. The code related to a package delivery can be associated with an action such as playing a pre-recorded message asking the deliverer to put the package by the back door.

In some variations, the message provided to a user's mobile device from the security device 202 can be a text message. The visitor's voice signals can be transcribed to text. In some variations, the security device 202 and/or an external voice analysis device, can be configured to determine a context of the recorded voice signals of the visitor. The context can be associated with one or more predetermined textual messages. The textual message(s) can be transmitted to the mobile device of a user. The mobile device can be configured to present the textual message(s) to the user. The mobile device can be configured to request a response from the user that is associated with the context of the recorded voice signals from the visitor.

In some variations, the user can be presented with one or more of predefined responses to select from. For example, the user can respond by selecting a message that causes the security device 202 to play a message to the visitor informing the visitor that the user is busy, or out of the building. In some variations, the user can respond by providing their own message. Their own message can be a voice message recorded and transmitted by the mobile device or a text message. A voice message can be transmitted to the security device 202 for playing to the visitor. A text message can be transmitted to the security device 202. The vocoder 224 can be configured to convert the text message into speech signals for playing through a speaker of the security device 202.

In some variations, a software application, or the like, can be provided. The software application can be configured to integrate with one or more email accounts, social media accounts, or the like, associated with a user of the security device 202. The software application can be configured to mine information associated with the user's email and/or social media accounts. When a visitor causes the security device 202 to be activated, an image of the visitor may be captured. Facial recognition software can be applied to the image of the visitor. Social media accounts, photographs and/or videos associated with the user can be mined using facial recognition software. The image of the visitor can be cross-referenced against images obtained from the social media accounts, photographs and/or videos, or the like to identify the identity of the visitor. In response to a match, the security device 202, and/or security system 200, can be configured to send a notification to the user of the security device 202 that includes the identity of the visitor.

In some variations, the software application may be configured to mine emails to determine when packages are likely to be left for the user. Image analysis of images obtained when a package is delivered can be configured to identify a type and/or size of package delivered, the identity of the delivery company (from logos on uniforms or vehicles), or the like. In response to an indication that a particular package was likely delivered, the user of the security device 202 can be notified of that fact.

An example of the functionality of the security device 202 can include a visitor coming to the door and pressing a button, such as button 106, on the security device. The security device 202 can be configured to respond with a pre-recorded audio message, for example “how may I help you?” A visitor may request a visit with a member of the household to which the security device 202 is affiliated. For example, the visitor may say “It is Nancy from across the street, I'm came by to see Sally.” Although multiple people associated with the household have mobile devices paired with the security device 202, the security device 202 can be configured to recognize that Sally's name was said by the visitor and route the message to Sally's mobile device only. In some variations, the visitor's message can be decoded and a text message can be transmitted to Sally's mobile device. For example, Sally's mobile device may present the following message: “Nancy from across the street came by to see you.”

In response, Sally's mobile device can be configured to facilitate selection of one or more options. One option can be to activate a 2-way voice communication between Sally's mobile device and the security device 202 facilitating two-way communication between Sally and Nancy. Another option can be to allow Sally to choose from a list of prerecorded messages, or allow Sally to type her own message. For example, “I'm in a meeting, but should be home soon.” Using text to speech technology the security device 202 can be configured to play a contextual message to Nancy “Sally says she's in a meeting, but should be home soon.”

As another example, A visitor can come to the door and the motion detector and/or camera can sense them approaching. The security device 202 can be configured to play a pre-recorded message, for example, “May I help you?” The visitor may respond with, for example, “It is DHL with a package for Lawrence.” The security device 202 can be configured to analyze the voice signals from the visitor, determine that Lawrence is a user at that location and determine the key words of “DHL” and “Package.” The security device can be configured to determine, from this analysis, that there is a package is for Lawrence.

The security device 202 can include one or more preferences associated with Lawrence. Based on the preferences the security device 202 can be configured to respond automatically with a message, for example, “please leave the package by the back gate.”

The security device 202 can be configured to transmit a message to Lawrence's mobile device informing Lawrence that he has a package waiting.

The security device 202 can be configured to facilitate deduction of the purpose of the visitor's visit based on one or more images captured by a camera, such as camera 104 or one or more other cameras paired with the security device 202. The security device 202 can include image analysis technology. The image analysis technology can be performed on the security device 202 or by a third-party service, such as at server 226. The image analysis technology can be configured to facilitate determination of the purpose of the visit by the visitor based on one or more visual cues. For example, the uniform worn by the visitor can be determined to be a delivery driver delivering packages. Facial recognition technology can be utilized to recognize acquaintances or people associated with the building to which the security device is attached.

The security device 202 can be used, for example, when a family member forgets their key to the house. A family member may request entry into the property from the security device 202. The security device 202 may capture an image of the person's face and use facial recognition technology to verify the identity of the visitor. In response to verifying that the visitor has permission to enter the property, the security device 202 can be configured to activate a lock on a door of the property unlocking the door and allowing entry by the visitor.

In some variations, the security device can include motion recognition technology. Based on the motion and actions of a visitor the security device 202 can be configured to determine whether or not the visitor has a nefarious intent. For example, if the visitor is trying to gain access to the property without identifying themselves and without the use of a key, the security device 202 may be configured to recognize that this action is nefarious. The security device 202 can be configured to act based on one or more preferences specified by a user. For example, the security device 202 can be configured to store images or video images associated with the nefarious visitor's actions, send a message to a user, contact authorities, or the like.

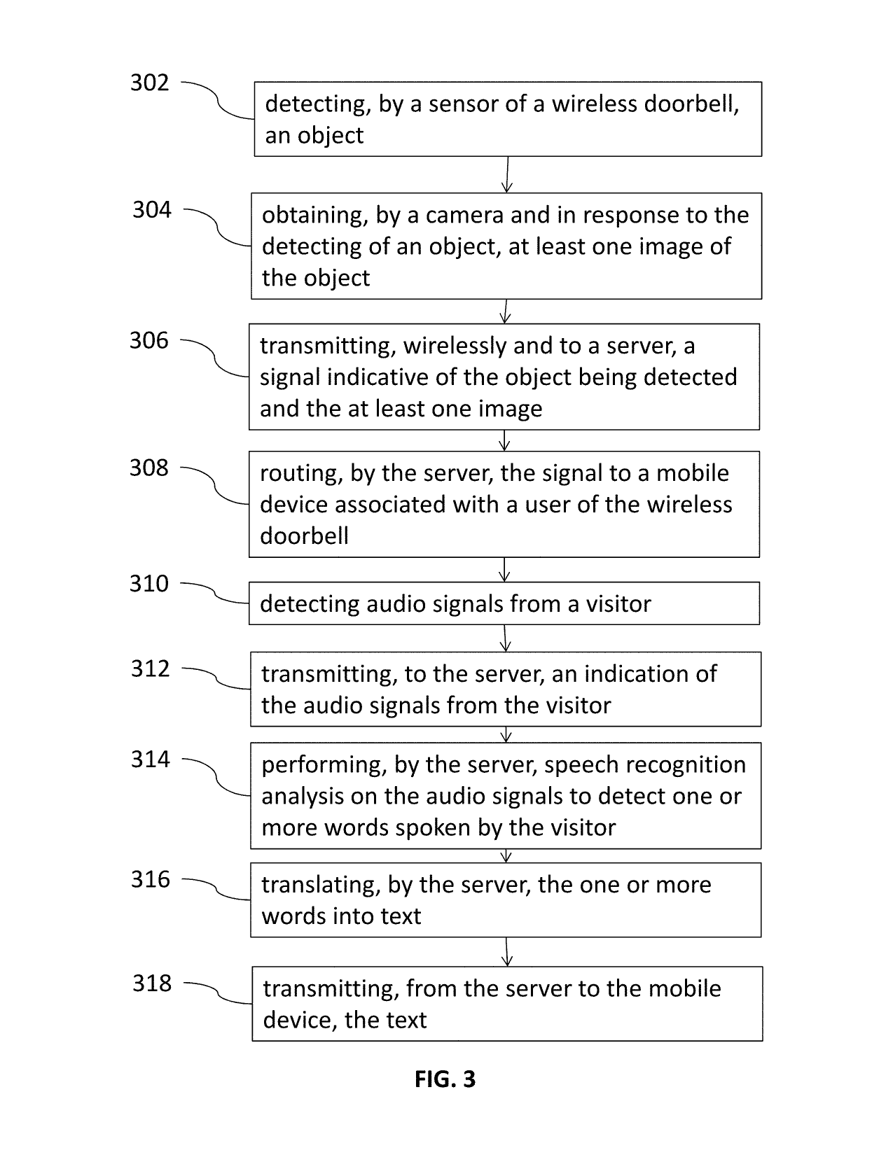

FIG. 3 is an illustration of a process 300 having one or more features consistent with the present description.

At 302, an object can be detected, by a sensor, in a vicinity of a wireless doorbell.

At 304, at least one image of the object can be obtained by a camera and in response to the detecting of an object.

At 306, a signal indicative of the object being detected and the at least one image can be transmitted wirelessly to a server.

At 308, the signal can be routed, by the server, to a mobile device associated with a user of the wireless doorbell.

At 310 audio signals can be detected from a visitor at the wireless doorbell.

At 312, an indication of the audio signals can be transmitted to the server from the wireless doorbell.

At 314, speech recognition analysis can be performed, by the server, on the audio signals to detect one or more words spoken by the visitor.

At 316, the one or more words can be translated into text.

At 318, the text can be transmitted from the server to the mobile device.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results.

Other implementations may be within the scope of the following claims.

What is claimed is:

1. A security system comprising:
a server; and
a wireless doorbell comprising:
a housing, the housing having a rear portion and a front portion, the rear portion configured to be secured to a support and the front portion configured to be secured to the rear portion;
a sensor configured to detect an object in a vicinity of the wireless doorbell;
a camera configured to be activated and obtain at least one image in response to the sensor detecting the object; and
a wireless transmitter configured to transmit, to the server, a signal indicative of the object being detected and the at least one image.

2. The security system of claim 1, wherein the server is configured to perform image recognition on the at least one image received from the wireless doorbell to determine an identity of the object.

3. The security system of claim 2, wherein the server is configured to transmit, to a mobile device of a user associated with the wireless doorbell, a notification of the detection of the object, the notification including the identity of the object.

4. The security system of claim 1, wherein the detected object is a visitor and the wireless doorbell further comprises a microphone for detecting audio signals from the visitor and wherein the signal includes an indication of the audio signals.

5. The security system of claim 4, wherein the server is further configured to:
perform speech recognition analysis on the audio signals to detect one or more words spoken by the visitor;
translate the one or more words into text; and
transmit the text to a mobile device associated with a user of the wireless doorbell.

6. The security system of claim 5, wherein the server is configured to determine a context of the text including an intended recipient of the audio signals and to transmit the text to the mobile device associated with the intended recipient.

7. The security system of claim 1, wherein the server is configured to:
receive a textual message from a mobile device associated with a user of the wireless doorbell;
convert the textual message to an audible message; and
transmit the audible message to the wireless doorbell for playing through a speaker of the wireless doorbell.

8. The security system of claim 1, wherein the wireless doorbell comprises a microphone and is configured to monitor sounds in the vicinity of the wireless doorbell over a period of time and generate a background noise profile based on the monitored sounds.

9. The security system of claim 8, wherein the wireless doorbell is configured to activate the camera in response to a detected sound exceeding one or more bounds of the background noise profile.

10. The security system of claim 1, wherein the wireless doorbell has a low power mode, the low power mode causing the camera to be inactive.

11. The security device of claim 1, wherein the server is configured to store the at least one image in electronic data storage.

12. The security device of claim 1, wherein the wireless doorbell is configured to enter an active mode in response to a signal received from a mobile device associated with a user of the wireless doorbell, the wireless doorbell being in an active mode causing the camera to obtain at least one image.

13. A method comprising:
detecting, by a sensor of a wireless doorbell, an object in a vicinity of the wireless doorbell;
obtaining, by a camera and in response to the detecting of an object, at least one image of the object;
transmitting, wirelessly and to a server, a signal indicative of the object being detected and the at least one image; and
routing, by the server, the signal to a mobile device associated with a user of the wireless doorbell.

14. The method system of claim 13, further comprising:
performing image recognition on the at least one image received from the wireless doorbell to determine an identity of the object; and
transmitting, to the mobile device of the user associated with the wireless doorbell, a notification of the detection of the object, the notification including the identity of the object.

15. The method of claim 13, wherein the detected object is a visitor and the method comprises:
detecting audio signals from the visitor;
transmitting, to the server, an indication of the audio signals from the visitor;
performing, by the server, speech recognition analysis on the audio signals to detect one or more words spoken by the visitor;
translating, by the server, the one or more words into text; and
transmitting, from the server to the mobile device, the text.

16. The method of claim 15, further comprising:
determining a context of the text including an intended recipient of the audio signals; and
transmitting the text to the mobile device associated with the intended recipient.

17. The method of claim 13, further comprising:
receiving, at the server, a textual message from a mobile device associated with a user of the wireless doorbell;
converting the textual message to an audible message; and
transmitting, from the server to the wireless doorbell, the audible message for playing through a speaker of the wireless doorbell.

18. The method of claim 13, further comprising:
monitoring, by a microphone of the wireless doorbell, sounds in the vicinity of the wireless doorbell over a period of time; and
generating a background noise profile based on the monitored sounds.

19. The method of claim 18, further comprising:
activating the camera in response to a detected sound exceeding one or more bounds of the background noise profile.

20. The method of claim 13, further comprising:
entering, by the wireless doorbell, an active mode in response to a signal received from a mobile device associated with a user of the wireless doorbell;
activating, in response to entering the active mode, the camera of the wireless doorbell.
